(19) United States
(12) Patent Application Publication
(10) Pub. No.: US 2012/0232980 A1
(43) Pub. Date: Sep. 13, 2012

(54) DONATION KIOSK

(76) Inventors: Jerry Wald, San Francisco, CA (US); Zack Fuerstenberg, Toronto (CA)

(21) Appl. No.: 13/414,313

(22) Filed: Mar. 7, 2012

Related U.S. Application Data
(60) Provisional application No. 61/449,929, filed on Mar. 7, 2011.

(51) Int. Cl. G06Q 20/22; H04W 4/16; G06Q 20/20; G06Q 30/02

(52) U.S. Cl. 705/14.27; 705/39; 705/21

(57) ABSTRACT

Methods, devices, and systems for charitable giving are disclosed. A consumer can set up a target amount of charitable giving that he or she wishes to pledge during a year, and amounts given toward that goal in various transactions can be summed and compared against the target. A consumer can change his or her target or contribution amounts based on projections toward a year-end date. Customer loyalty points, such as reward points, airline miles, hotel stays, etc. can be converted to cash equivalents and given to charity toward the personal goal if they are about to expire and could be used to meet a targeted charitable amount. Web portals and wireless kiosks located in public areas can accept payments, update users on their gift levels, and generally remind people to contribute to charity.

### CROSS-REFERENCES TO RELATED APPLICATIONS

This application claims the benefit of U.S. Provisional Patent Application No. 61/449,929, filed Mar. 7, 2011, which is hereby incorporated by reference in its entirety for all purposes.

### BACKGROUND

1. Field of the Art

Systems, devices, and methods are disclosed for setting up and controlling accounts for donating to charities including computerized kiosks for accepting charitable donations. Specifically, allowing users to configure their own charitable donation targets, sending reminders for those targets to the consumer, determining whether expiring reward points or other non-governmental currencies can be used to reach the targets, and hosting prominent kiosks for accepting card-swipe charitable donations are described.

2. Discussion of the Related Art

Enlightened minds donate to charitable causes. However, sitting down to actually collect clothing, find canned goods, peel soup can labels, or write a check to a charity can sometimes be forgotten. One may have good intentions to donate at some point but fail to follow through. The distractions of the day, busy modern lifestyles, and competing interests beg for one's time, drowning out the memory to help a charitable cause.

It is often easy to forget to donate until the last minute, such as the end of a tax year or a charity's well publicized contribution campaign. However, donating a substantial amount all in one sum can be daunting. Methods have been devised for giving a small amount at many times during a year, for example with each purchase transaction.

U.S. Pat. No. 6,112,191 to Burke, issued Aug. 29, 2000, is directed toward setting aside amounts, such as the difference between a purchase price for an item and the next ‘rounded up’ dollar, and donating the various set-aside amounts in one sum to charity. By setting aside small, under $1.00 amounts in each of many transactions during a year, a consumer can accrue a substantial sum without feeling the pain of making the sum of money at one time.

U.S. Pat. No. 7,577,604 to Ogilvie, issued Aug. 18, 2009, is directed to specified savings accounts using incremental commitments during consumer transactions. Consumers can enter an agreement with a credit card issuer in which the consumers' credit card bills reflect not only merchandise charges for payment transactions but also incremental savings charges. When the credit card bills are paid by the consumers, the credit card issuer automatically deposits the extra savings amounts in the respective consumer's specified savings account.

While such mechanisms allow for consumers to more easily save for charitable donations, there exists a need to encourage and facilitate more charitable donations to worthy causes.

### BRIEF SUMMARY

Generally, methods, devices, and systems are presented for planning, configuring, tracking, and being reminded of charitable donations. Users are able to set their own charitable giving targets for the year, configure incremental quasi-automatic gift-giving during the year, and be sent alerts if their gift-giving configuration is estimated to cause the charitable targets to be missed.

A consumer can set up a charitable target and make relatively small payments to reach the target. The consumer can set up conditional controls depending on the type of charity or foundation to which he or she wishes to donate. If a donation rate over the course of time for the consumer does not appear to be able to reach the consumer's target for the time period, then a reminder can be automatically sent to the consumer. Equivalent cash value of the consumer's reward points, airline miles, or other consumer loyalty points can be calculated and offered to the consumer as an option to meet the consumer's donation goal.

The equivalent cash value of expiring consumer loyalty points can be calculated and offered to a user for donation. The offer can be triggered by the expiration date of the points, the end of the period for the consumer's charitable gift-giving goals, or other events.

A physical kiosk can be used for donations to charities. A user of the kiosk can swipe a credit card, insert loose change, log in to reward account, or otherwise tender value towards a charitable contribution. In alternative embodiments, a web portal accessible on the Internet can replace a kiosk.

Some embodiments in accordance with the present disclosure relate to a method of alerting users to charitable target amounts. The method includes receiving a charitable target amount and target date from a user, withholding a set-aside amount from a payment transaction for the user, the payment transaction including a payment for a product or service and the set-aside amount, adding the withheld set-aside amount to the sum of set-aside amounts, estimating, using a processor operatively coupled with a memory, whether a sum of set-aside amounts from the user will fall below the target amount by the target date, and sending a message to the user based on the determination.

The method can include receiving a modification to the charitable target amount from the user in response to the message, re-estimating whether the sum of charitable donations from the user will fall below the charitable target amount by the target date, and performing an action based on the re-estimation.

The method can include determining a value of customer loyalty points held by the user, and proposing, in the message, to convert the customer loyalty points to a set-aside amount to be credited toward the charitable target amount.

Some embodiments in accordance with the present disclosure relate to a method of alerting users to a charitable opportunity. The method includes receiving information on a payment transaction for a user, the payment transaction including a payment for a product or service and a set-aside amount, comparing a sum of set-aside amounts to a charitable target amount, the sum of set-aside amounts including the set-aside amount in the payment transaction, determining, using a processor operatively coupled with a memory, an expiration date of customer loyalty points for a user, sending a message to the user based on the determination, and converting the points to a government-issued currency based on a user's response to the message.

Some embodiments in accordance with the present disclosure relate to a kiosk apparatus for accepting charitable contributions. The kiosk includes a housing, a display coupled with the housing, a network interface, and a processor operatively coupled with the display and network interface, the processor configured to allow a user to select a charitable organization to whom to donate, accept a payment to a selected charitable organization, and credit, through a connection using the network interface, the selected charitable organization with the payment.

The apparatus can further include program code executable by the processor for determining, using the network interface, a value of customer loyalty points held by the user, receiving an authorization from the user, and transferring the customer loyalty points from the user to the charitable organization. The apparatus can also include program code executable by the processor for determining an expiration date of the customer loyalty points, and notifying the user of the value of customer loyalty points based on the expiration date.

Other embodiments relate to machine-readable tangible storage media and computer systems that employ or store instructions for the methods described above.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates a kiosk in accordance with an embodiment.

FIG. 2 illustrates an alternate kiosk in accordance with an embodiment.

FIG. 3 is a chart of an accrued sum of set-aside amounts and target donation amount in accordance with an embodiment.

FIG. 4 illustrates a display screen for a consumer in accordance with an embodiment.

FIG. 5 illustrates a system for donations using a payment service provider in accordance with an embodiment.

FIG. 6 is a flowchart of a process in accordance with an embodiment.

FIG. 7 is a flowchart of a process in accordance with an embodiment.

FIG. 8 shows a block diagram of an exemplary computer apparatus that can be used in some embodiments.

The figures will now be used to illustrate different embodiments in accordance with the invention. The figures are specific examples of embodiments and should not be interpreted as limiting embodiments, but rather exemplary forms and procedures.

### DETAILED DESCRIPTION

Methods, devices, and systems for planning, configuring, tracking, and reminding users of charitable donations are presented. Users can establish their own target amount for giving to charities over a given time. The users can configure their payment card accounts or other payment accounts to donate small amounts of money over the course of the given time. The gift withholding can occur in response to events that the users initiate (e.g., a purchase) or periodically (e.g., once a month). For example, payment amounts for merchandise or services can be rounded up to the nearest dollar, and the rounded up amount can be set aside in an charitable account. The amount in the charitable account can be tracked to estimate whether it will reach the target amount.

If it looks as though the target amount will not be reached by the target date, then a notification can be sent to the user. The notification can include the total amount saved so far, the projected deficit between the amounts to be saved and the target amount, and suggestions for achieving the target amount. For example, if rounding up each purchase to the next whole dollar is not setting aside enough money, then rounding up and adding a dollar to each transaction can be suggested.

Customer loyalty points, such as rewards points, airline miles, hotel stays, Zynga® dollars, etc. held by the consumer can be offered for payment if transferable. The cash equivalent of the loyalty points can be used to compare their value with that of the user's target amount. For example, 20,000 airline miles valued at 1¢ per mile can be valued at $200, if donated. If a user is short of his or her target at the end of the giving period, then such loyalty points may be presented to the user as an option for giving. If the points are about to expire, then they may be presented to the user. For example, if 20,000 airline miles are about to expire in two months, then a message can be sent to the user asking whether to donate these miles to a charitable cause and credit the gift to the user's personal target. A tax receipt can be automatically sent to the user if the user agrees to convert the expiring miles.

A physical kiosk can be set up in airports, grocery stores, shopping malls, and other public places for charitable giving. Kiosks can be visibly placed to remind people to donate. The kiosks can be networked, through wired or wireless connections, in order to access credit card or other financial account information of a user. A payment card can be swiped, read, etc. in order to accept charitable donations.

Some kiosks can accept coins and other change. A user may bring a jar or bag of extra pennies, etc. that have accumulated over the years, and the kiosk can automatically count the change. The kiosk can offer to credit some or part of the totaled amount to the user's preferred charity. If there is not enough change to fulfill a particular obligation on the part of the user, the user can be asked to give more from his or her payment accounts or from customer loyalty points that are about to expire. The kiosk can connect through a payment service network to access the user's preferred charity(ies) and pay the charity(ies) directly.

The kiosks can incorporate games, such as slot machine games or games of chance, such that winning proceeds are credited toward a player's personal target amount or automatically sent to his or her charity of choice.

Although charitable donation bins and coin baskets in public places are in the prior art, such bins and baskets are not networked into a system, are not integrated with personal, user-customized charitable target amounts, and bins and baskets do not accept credit cards.

Technical advantages of the aspects of the invention are many. By setting up a charitable target and annuitizing the payments to reach the goal, consumers can conveniently make one or more major donations and not be negatively affected by the upfront costs of one major payment. By using a KEEP THE CHANGE® service type of donation concept, consumers can automatically pay off their goal of donating while only having a minimal effect on their daily finances. By setting up conditional controls based on certain types of charities or foundations, consumers can be assured their donations are going to their favorite charities or foundations in their favored preference. Sending the consumer a reminder of their donation commitment can keep consumers accountable for their charitable target and allow the consumer to actively increase their charitable transactions to reach their goal, leading to an increase in charitable donations. Receiving the donation goals and actual set-aside sums can allow charities and foundations to more accurately forecast their incoming donations.

Donation kiosks can act as reminders to consumers of their pre-existing charity targets as well as advertisements to new consumers. New consumers may see their friends, family, and neighbors using the kiosks and be encouraged to donate.

By providing information about different charities and foundations through a kiosk or web portal, consumers can be informed of lesser known charities and foundations, leading to a wider dispersion of funds to charities that otherwise would not have as much consumer visibility. By setting up a charitable target and annuitizing the payments to reach the goal, consumers can better forecast their donation spending through the year while spreading the cost over a long period. Automatic payments can be more efficient for charities and foundations who will not have to hire employees or recruit volunteers to solicit and process donations.

Allowing users to donate to charities using their rewards currency will lead to more donations to charities and foundations as users are given more choices of how to spend their reward points. Alerting a user of expiring reward points and asking the user to donate the points will lead to more economic efficiency as less reward points will go to waste before consumers can decide how to spend their points.

Providing consumers the ability to donate change to charities directly via a currency acceptance machine, such as a COINSTAR® machine, can be a faster and more efficient donation process than printing receipts that must be redeemed by the consumer and then donated. Providing direct donations of change through coin counting machines will lead to more donations to charities as users are provided more choices on how to spend their collected change.

A “charitable target amount” includes an amount of money that is targeted to be set aside for charity by a person, or as otherwise known in the art.

A “set-aside amount” includes an amount of money that part of a larger transaction but is set aside for giving to charity, or as otherwise known in the art. An example of a set-aside amount is an amount of $0.25 out of a $50.00 transaction, where the $0.25 is set aside for a charitable donation.

A “government-issued currency” includes money or equivalents issued by a sovereign state or as otherwise known in the art. Some examples of government-issued currency include American Dollars, Euros, British Pounds, and Japanese Yen.

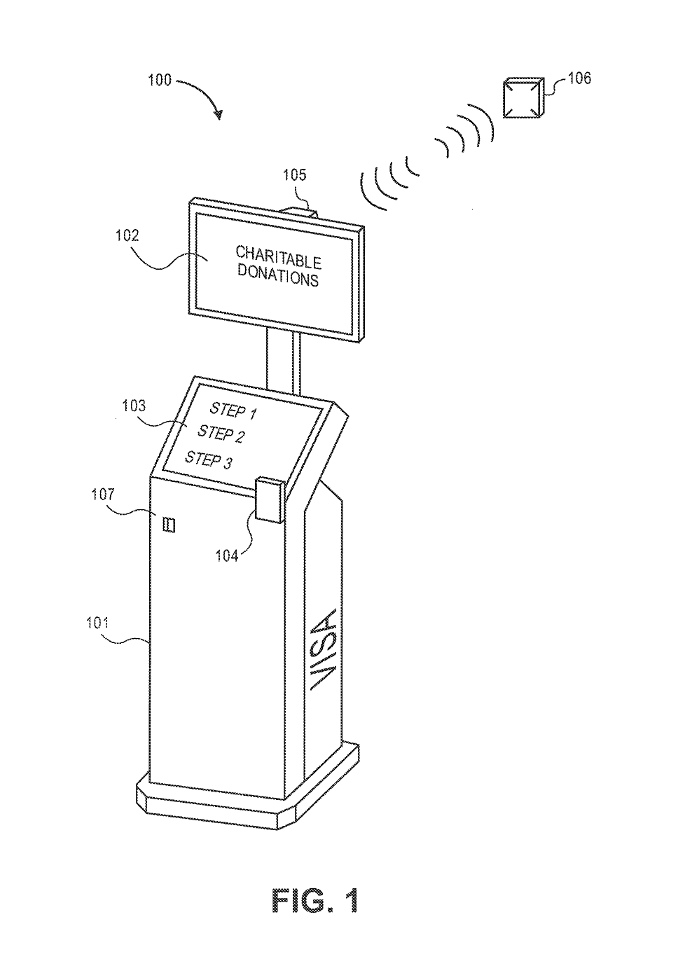

FIG. 1 illustrates a kiosk in accordance with an embodiment. System 100 includes kiosk 101 with display 102 and touch screen display 103 surrounded by a housing. Display 102 is placed high so that others can seen a game that a user of the kiosk is playing or how much a user has donated to a charity. Display 102 can show advertisements, videos of those in need, and other images. Touch screen display 103 can accept user inputs, including account passwords, connection information, preferred charities, search queries for charities, and other inputs. The touch screen can be vandal-resistant and/or weather resistant so that it can be placed in many environments.

Card reader 104 can read payment cards, barcodes shown on cellular phones, and other physical devices associated with payment accounts. A user can swipe a credit card through card reader 104 in order to set aside money to provide to charity or move a payment device, such as a smart phone programmed with an electronic wallet, in close proximity to the reader so that it can be read.

Coin slot 107 can accept coins for counting. In some embodiments, a basket can accept coins being poured in. The basket can churn through the coins and count them as is known in the art.

Kiosk 101 can communicate via wireless interface 105 with fixed transceiver 106 in order to connect with a network, such as the Internet. Wireless communications can be facilitated by Bluetooth®, IEEE 802.11, or other communication protocols. The communications can enable the kiosk to update the user's giving account, display the user's progress toward achieving a charitable gift-giving goal, access customer loyalty points web sites and web services, etc.

Displays on the kiosk can be web browser based, through HTML, JavaScript, Java, and other client-side code, and couple with server-side web portal code, such as that written in Microsoft Active Server Pages (ASP), PHP, Perl, and other computer languages as known in the art. The displays can run non-web browser based code instead of or in addition to web based code. For example, native C/C++ applications can run on the kiosk.

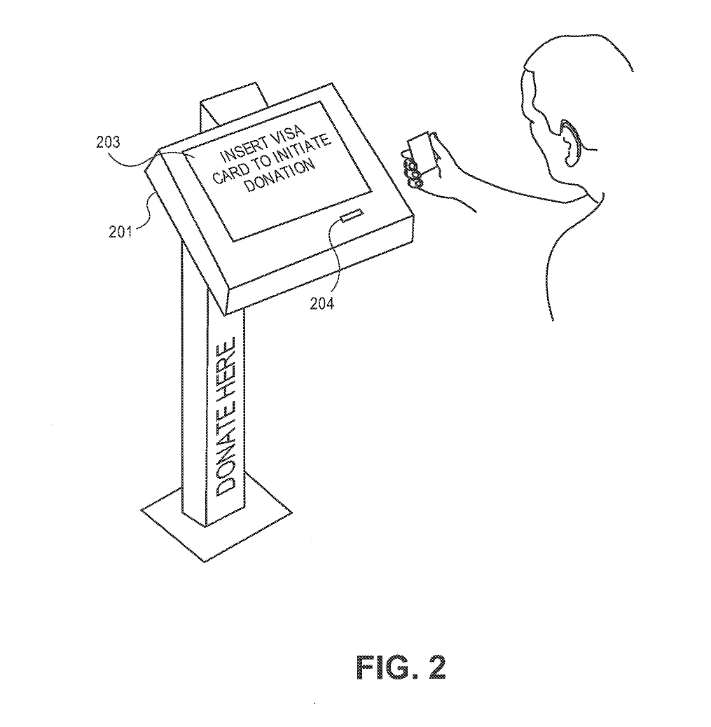

FIG. 2 illustrates an alternate kiosk in accordance with an embodiment. Small kiosk 201 includes touch screen 203 and card slot 204. A user can use the kiosk to donate money, check on accounts, or perform other transactions. The user can display his or her charitable target amount for a time period and the progress that is being made toward achieving the target.

Kiosk 201 can encourage users to donate more money, donate loyalty points, set target amounts and associated dates, and otherwise commit resources to charity.

Local charities can be featured on the kiosk, as determined by programming in the kiosk itself. The kiosk may sense that it is in a particular geographic region, and based on its location, display charities that are local. For example, a kiosk may determine through a Global Positioning System (GPS) antenna that it is near the address of a local YMCA, a Salvation Army drop off location, and a Humane Society animal shelter. Based on this address look up, the kiosk can feature the local YMCA, Salvation Army drop off, and Humane Society at the top of its list of charities to which one can donate.

Kiosk 201 is small, light, and compact enough to be portable. One person can carry the kiosk to another location and bolt it to the floor with tamperproof hardware. Moving donation kiosks rapidly can be important for conventions, church services, and other events in which crowds ebb and flow at times.

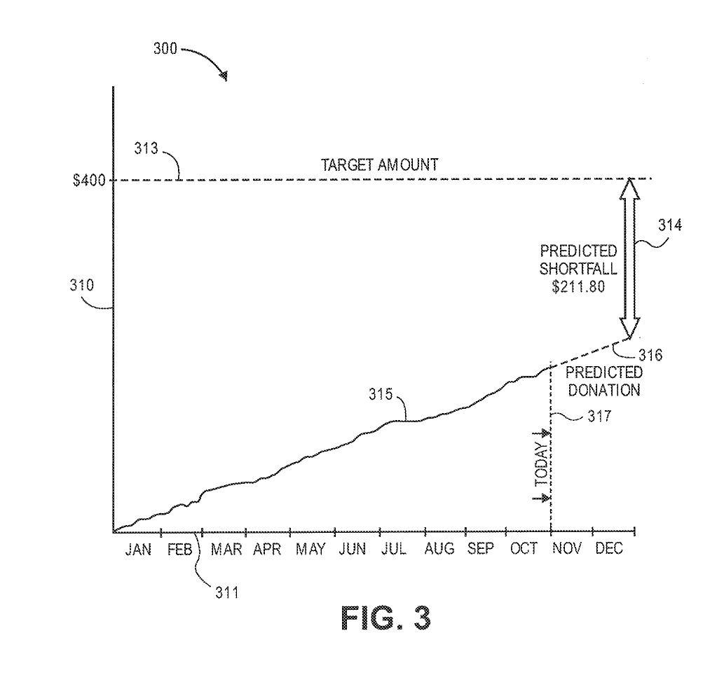

FIG. 3 is a chart of an accrued sum of set-aside amounts and target donation amount in accordance with an embodiment. Chart 300 includes dollar amount (vertical) axis 310, month (horizontal) axis 311, and the user's personal target amount 313.

Actual withholding from various transactions, such as ‘round up’ withholding, is displayed as sum of set-aside amounts line 315 up until current date 317. Beyond current date 317, the user's rate of donation is extrapolated. Extrapolation can be linear, polygonal, exponential, or other extrapolation techniques as known in the art. Predicted sum of donations 316 is extrapolated to the end of the time period. In the exemplary embodiment, the time period ends at the end of the year on December 31.

Predicted shortfall 314 is calculated by subtracting target amount 313 from the predicted sum of donations 316 at December 31. This predicted shortfall amount can be used to notify the user as well as come up with solutions on how to achieve the target amount. If the user's predicted sum of donations is higher than the target amount, then no notification may be sent. If the user's predicted sum of donations is lower than the target amount, as shown, then the notification can be triggered.

For example, if the user has 20,000 airline miles valued at 1¢ per mile, then $200 of the $211.80 predicted shortfall amount can be filled by simply donating the airline miles. This can make sense to a user, especially if the airline miles are about to expire anyway.

“About to expire” points may be point that expire within ninety days, two months, 60 days, a month, thirty days, a week, 6, 5, 4, 3, 2, or 1 days, or sooner. It may take time for the points to be converted to a dollar amount and transferred, so the expiration date can be compensated accordingly.

Depending upon the urgency (i.e., lack of time between today's date and the deadline) and/or the predicted shortfall amount, the notification can be sent by mail, email, short message service (SMS) or multimedia messaging service (MMS) text message, instant message, or otherwise.

A user may receive the notification and send a reply to modify his or her charitable target amount. For example, a user can reply to the notification email with a selection to adjust his target amount from $400 on December 31 to $200. Based on the reply for the modification of the charitable target amount, a central computer can re-estimate whether the sum of the user's charitable donations accrued so far will be projected to fall below the new charitable target amount by the due date. For example, the projected amount will be $11.80 short of the $200 amount on December 31. That re-estimation may trigger another action, such as sending an email to the user's selected charity with the newly modified target amount and accrued amount so that the charity can better estimate its income.

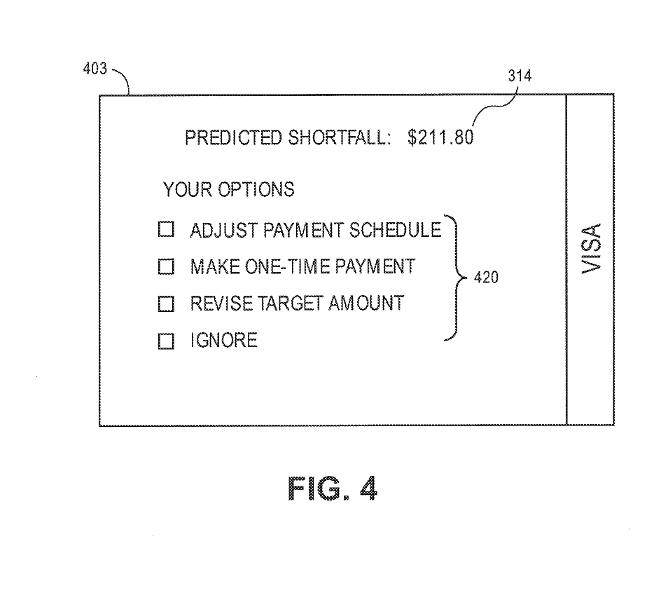

FIG. 4 illustrates a display screen for a consumer in accordance with an embodiment. Display screen 403 shows predicted shortfall 314 as well as options 420. The options can include adjusting one's payment schedule, making a one-time payment from a payment account, revising the target amount, or simply ignoring the notice. Adjusting the payment schedule can include, for example, not only setting aside rounded up amounts from credit card transactions, but also periodically (e.g., daily) setting aside a few dollars toward the charitable goal.

A menu can appear after the user selects the make one-time payment selection. The menu can include a list of expiring customer loyalty points and their cash equivalents, a credit/debit card list, insert coin prompt, or other menu items.

For additional privacy, customers can be notified of the shortfall via text or multimedia messages, interactive voice prompts, instant messages, or emails to their cellular phones or other electronic devices. This notification can occur if the user is projected to fail to meet his or her personal target amount at a specific time. For example, a message can be sent mid-year (i.e., June 30) indicating the projected shortfall amount and/or a message can be sent one month before the target date (i.e., November 30 if the target date is December 31).

Charitable organizations can better predict income streams if they have access to personal targets. At the beginning of a fiscal year, an organization can receive a roll-up of target amounts for individuals who have pledged to withhold money on their behalf. The rolled up target amount can indicate, after discounting by a predetermined factor, how much the organization can budget for its various programs.

A central computer can forecast an aggregate charitable target amount from multiple users' charitable target amounts. The sum of all the target amounts of users who have targeted to give certain amounts can be one way of compiling the forecast. Another way can be to take that sum and discount it by a certain amount or percentage. For example, the sum of all the target amounts can be discounted by 50% to account for people changing their minds later, not meeting their goals, or simply to be conservative in an estimate.

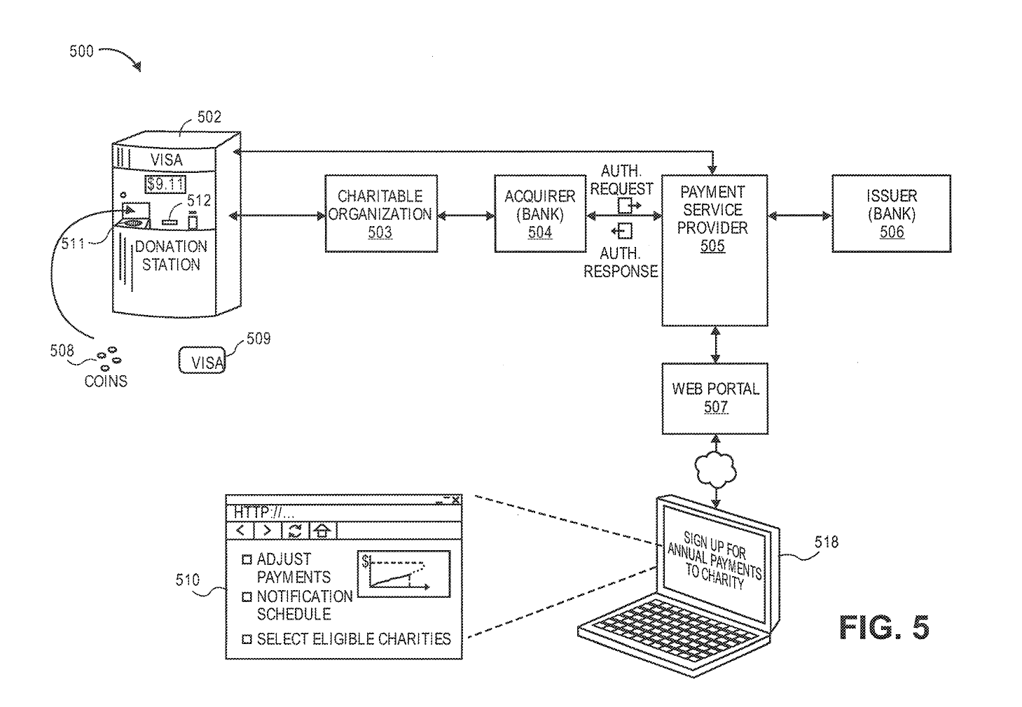

FIG. 5 illustrates a system for donations using a payment service provider in accordance with an embodiment. Payment service provider 505, sometimes called a payment processing network, is configured to process credit card transactions, debit card transactions, or other portable consumer device transactions. Data relating to such transactions, including purchases, refunds, etc., can be referred to as payment data.

A user can sign up in advance for a charitable contribution account through a payment service provider, such as Visa. The user accesses web page 510, through web portal 507, in order to register for the service. Web portal 507 communicates the user's preferences, settings, and account through a connection with payment service provider 505. Later, the user may find himself in a position where he has excess money to donate and some time to perform the donation.

Coin counting kiosk 502 is at a foreign airport. As the user waits at the airport for his flight home, jingling the foreign currency that he has collected in his pockets that he cannot spend at home, he sees the coin counting kiosk machine. The user pours accumulated coins 508 into machine hopper 511, inserts any foreign currency bills into bill slot 512, and waits for it to add up his change. The machine counts the bills and coins and displays the amount, converted to U.S. dollars, to the user.

At this point, the user may convert the amount to U.S. dollars and credit the value to his account, minus a fee. The user may also be prompted to donate the amount to a charity of his choosing.

The user swipes credit card 509, through a reader on the kiosk for identification purposes. The machine, or servers at the payment service provider, recognize the user and prompt him for a password to log in. The kiosk is then configured to communicate to one or more of the pre-selected charities of the user's choice.

If the user elects to donate the money to charitable organization 503, the machine connects with a web service of the charitable organization and automatically enters the user's credit card number. Charitable organization 503 sends a standard payment authorization request message to its acquirer bank, acquirer 504, which in turn routes the authorization request message to payment service provider 505. Payment service provider 505 sends the authorization request message to the user's bank, issuer 506. Issuer 506 is the bank that issued the user's credit card, credit card 509.

After verifying that there are enough funds in the user's account, the issuer sends an authorization response message back to payment service provider 505, which in turn routes it back to acquirer 504. An authorization response message is returned to charitable organization 503, and the funds are accepted. The value of the foreign currency is effectively credited to the charity.

A technical advantage of this embodiment is that the charitable organization can be paid faster through the payment service provider's network than many other forms of payment. Also, the user gets rid of his coins, which might have little worth in his home country. It may also help him get rid of metal on his person before entering X-ray scanners, metal detectors, and other airport screening devices that detect metal. The kiosk allows the user to check his own personal targets for giving to charity while waiting for a flight and can offer him recommendations on how to meet his targets.

The system can be used for domestic currency, bills, and other valuable consideration. For example, old cellular phones can be dropped off, appraised by using their barcode model and/or serial number, and their value can be instantly credited through the system to the user's charity of choice.

In some embodiments, the kiosk itself can be configured to act as a card reader/terminal for the charitable organization. The kiosk communicates directly with the acquirer instead of through a web service or other automated communication interface, sending information from a magnetic strip, chip, etc. on the card to the acquirer in order to assemble the authorization request message. This accelerates the transaction, lowers the number of communication channels or hops that are needed, and lessens the need for the charity to have its own communication service.

The system can directly apprise and update the charitable organization as to a user's changed preferences regarding target amounts as well as money accrued towards those target amounts. If a user changes a target amount, the charity at issue can plead its case for greater donations or thank the user for his generosity while he is at the kiosk.

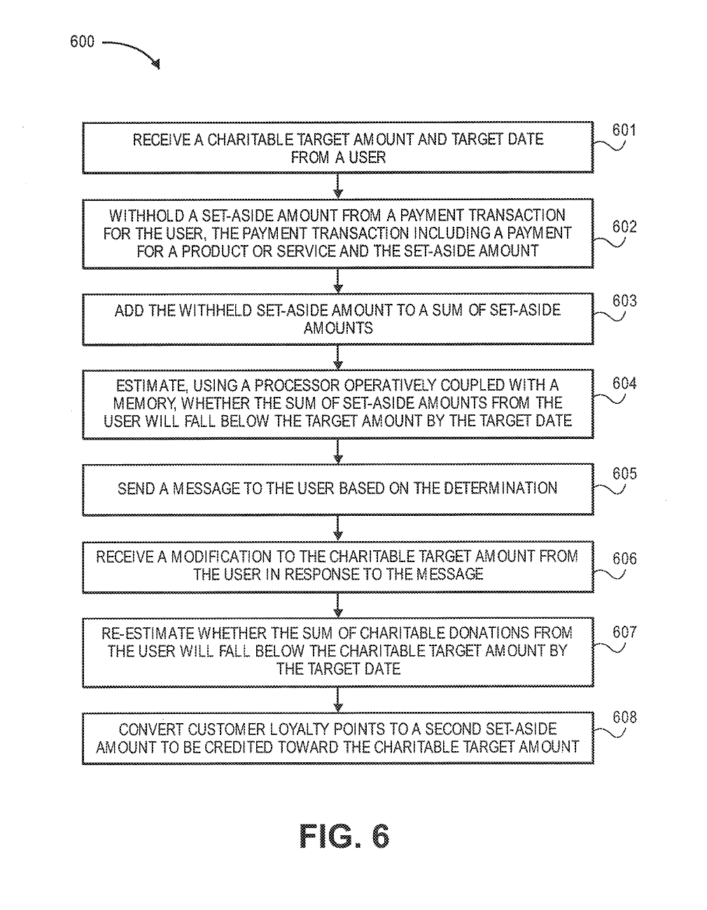

FIG. 6 is a flowchart of a process in accordance with an embodiment. Process 600 can be implemented by a computer or other machine.

In operation 601, a charitable target amount and target date are received from a user. In operation 602, a set-aside amount is withheld from a payment transaction for the user, the payment transaction including a payment for a product or service and the set-aside amount. For example, the payment can be $12.00, including $11.35 for lunch at a cafeteria and $0.65 for the set-aside amount. In operation 603, the withheld set-aside amount is added to a sum of set-aside amounts. For example, the $0.65 set-aside amount is added to an account of previous set-aside amounts of $106.21, to total $106.86. In operation 604, a processor operatively coupled with a memory estimates whether the sum of set-aside amounts from the user will fall below the target amount by the target date. For example, a computer estimates that at a rate of $0.65 per work day for lunch, the total set-aside amounts at the end of the year will fall below the user's target amount of $400. In operation 605, a message is sent to the user based on the determination. In operation 606, a modification to the charitable target amount is received from the user in response to the message. in operation 607, whether the sum of charitable donations from the user will fall below the charitable target amount by the target date is re-estimated. In operation 608, customer loyalty points are converted to a second set-aside amount to be credited toward the charitable target amount.

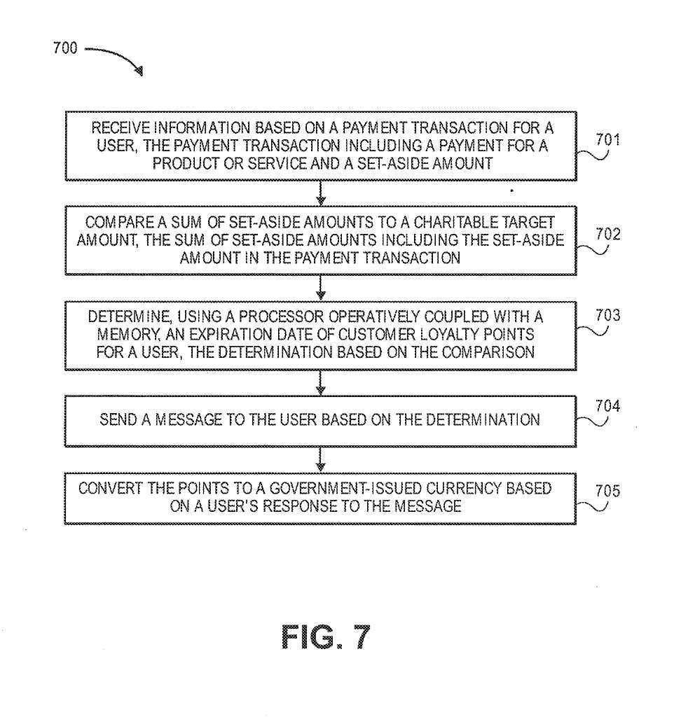

FIG. 7 is a flowchart of a process in accordance with an embodiment. Process 700 includes operations.

In operation 701, information on a payment transaction for a user is received, the payment transaction including a payment for a product or service and a set-aside amount. In operation 702, a sum of set-aside amounts is compared to a charitable target amount, the sum of set-aside amounts including the set-aside amount in the payment transaction. In operation 703, a processor operatively coupled with a memory determines an expiration date of customer loyalty points for a user, the determination triggered by or otherwise based on the comparison. In operation 704, a message is sent to the user based on the determination. In operation 705, the points are converted to a government-issued currency based on a user's response to the message.

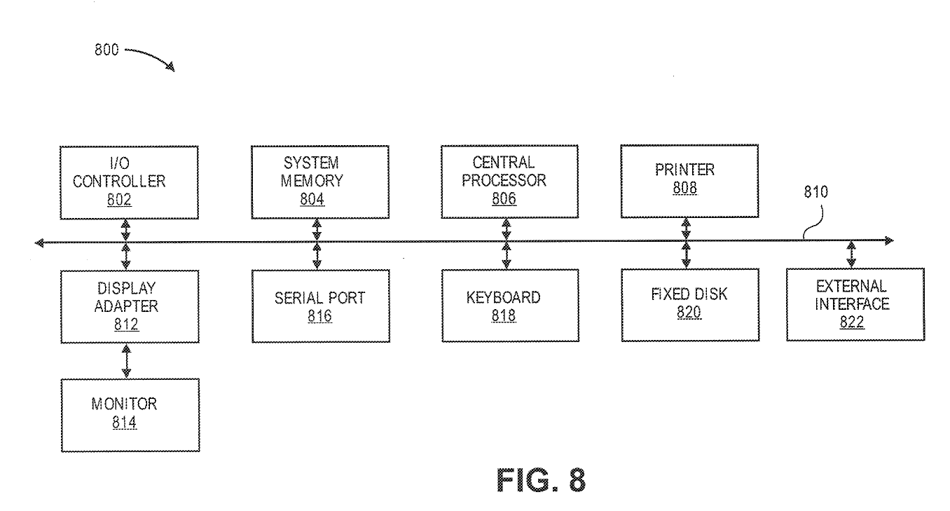

FIG. 8 shows a block diagram of an exemplary computer apparatus that can be used in some embodiments. The subsystems shown in the figure are interconnected via a system bus 810. Additional subsystems such as a printer 808, keyboard 818, fixed disk 820 (or other memory comprising computer readable media), monitor 814, which is coupled to display adapter 812, and others are shown. Peripherals and input/output (I/O) devices, which couple to I/O controller 802, can be connected to the computer system by any number of means known in the art, such as serial port 816. For example, serial port 816 or external interface 822 can be used to connect the computer apparatus to a wide area network such as the Internet, a mouse input device, or a scanner. The interconnection via system bus allows the central processor 806 to communicate with each subsystem and to control the execution of instructions from system memory 804 or the fixed disk 820, as well as the exchange of information between subsystems. The system memory 804 and/or the fixed disk 820 may embody a tangible computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of alerting users to charitable target amounts, the method comprising:
receiving a charitable target amount and target date from a user;
withholding a set-aside amount from a payment transaction for the user, the payment transaction including a payment for a product or service and the set-aside amount;
adding the withheld set-aside amount to a sum of set-aside amounts;
estimating, using a processor operatively coupled with a memory, whether the sum of set-aside amounts from the user will fall below the target amount by the target date; and
sending a message to the user based on the determination.

2. The method of claim 1 further comprising:
receiving a modification to the charitable target amount from the user in response to the message;
re-estimating whether the sum of charitable set-aside amount from the user will fall below the charitable target amount by the target date; and
performing an action based on the re-estimation.

3. The method of claim 1 further comprising:
forecasting an aggregate charitable target amount from multiple users' charitable target amounts, the multiple users' charitable target amounts including the charitable target amount from the user; and
sending the forecast aggregate charitable target amount to a charity.

4. The method of claim 1 further comprising:
calculating an aggregate sum of charitable donations from multiple users' sums of set-aside amounts, the multiple users' sums of set-aside amounts including the sum of set-aside amounts; and
sending the calculated aggregate sum of charitable donations to a charity.

5. The method of claim 1 further comprising:
determining a value of customer loyalty points held by the user; and
proposing, in the message, to convert the customer loyalty points to a second set-aside amount to be credited toward the charitable target amount.

6. The method of claim 5 wherein the performing an action includes converting the customer loyalty points to the second set-aside amount to be credited toward the charitable target amount.

7. The method of claim 5 wherein the proposing is based on a determination that the customer loyalty points are about to expire.

8. The method of claim 1 wherein the message is in a format selected from the group consisting of an email, short message service (SMS) text message, multimedia messaging service (MMS) message, and instant message.

9. The method of claim 1 wherein the message includes the charitable target amount.

10. The method of claim 1 wherein at least some of the charitable donations are in government-issued currency.

11. The method of claim 1 wherein at least some of the charitable donations are in the form of reward points.

12. The method of claim 1 wherein the operations are performed in the order shown.

13. The method of claim 1 wherein each operation is performed by the processor operatively coupled to a memory.

14. A machine-readable tangible storage medium embodying information indicative of instructions for causing one or more machines to perform the operations of claim 1.

15. A computer system executing instructions in a computer program, the computer program instructions comprising program code for performing the operations of claim 1.

16. A method of alerting users to a charitable opportunity, the method comprising:
receiving information on a payment transaction for a user, the payment transaction including a payment for a product or service and a set-aside amount;
comparing a sum of set-aside amounts to a charitable target amount, the sum of set-aside amounts including the set-aside amount in the payment transaction;
determining, using a processor operatively coupled with a memory, an expiration date of customer loyalty points for a user, the determining based on the comparison;
sending a message to the user based on the determination; and
converting the points to a government-issued currency based on a user's response to the message.

17. The method of claim 16 wherein the expiration date is within ninety days, a month, thirty days, or a week of sending the message.

18. The method of claim 16 wherein the customer loyalty points are selected from the group consisting of miles, reward points, casino chips, and non-governmental-issued currency.

19. A kiosk apparatus for accepting charitable contributions, comprising:
a housing;
a display coupled with the housing;
a network interface;
a processor operatively coupled with the display and network interface, the processor configured to accept a payment to a selected charitable organization, and credit, through a connection using the network interface, the selected charitable organization with the payment.

20. The apparatus of claim 19 further comprising program code executable by the processor, including:
program code for determining charitable organizations local to the kiosk apparatus; and
program code for displaying the determined local charitable organizations to the user for selection.

21. The apparatus of claim 19 further comprising program code executable by the processor, including:
program code for determining, using the network interface, a value of customer loyalty points held by the user;
program code for receiving an authorization from the user; and
program code for transferring the customer loyalty points from the user to the charitable organization.

22. The apparatus of claim 21 further comprising program code executable by the processor, including:
program code for determining an expiration date of the customer loyalty points; and
program code for notifying the user of the value of customer loyalty points based on the expiration date.

23. The apparatus of claim 19 wherein the customer loyalty points are selected from the group consisting of miles, reward points, casino chips, and non-governmental-issued currency.

24. The apparatus of claim 19 further comprising:
a wireless interface operatively coupled with the network interface.

25. The apparatus of claim 19 wherein the kiosk apparatus is portable.
